(19) United States
(12) Patent Application Publication
(10) Pub. No.: US 2018/0315530 A1
(43) Pub. Date: Nov. 1, 2018

(54) METHOD AND APPARATUS FOR COOLING A SUPERCONDUCTING DEVICE IMMERSED IN LIQUID NITROGEN

(71) Applicant: Victoria Link Ltd., Wellington (NZ)

(72) Inventor: Michael Philip STAINES, Days Bay, Lower Hutt (NZ)

(21) Appl. No.: 15/768,409

(22) PCT Filed: Oct. 13, 2016
(86) PCT No.: PCT/IB16/56141

§ 371 Date: Apr. 13, 2018

Related U.S. Application Data
(60) Provisional application No. 62/242,202, filed on Oct. 15, 2015.

(51) Int. Cl. H01F 6/04; H01F 36/00

(52) U.S. Cl. CPC H01F 6/04; H01F 36/00

(57) ABSTRACT

A cryogenic cooling system for a superconducting device includes a thermally insulated cryostat for containing liquid nitrogen in which the superconducting device immersed, a cryocooler for cooling the superconducting device, and a cryogenic fluid circuit for thermally coupling the superconducting device to a cold head of the cryocooler. The cryogenic fluid circuit includes a heat exchanger in the cryostat for immersion in the liquid nitrogen, a condenser thermally coupled to the cold head, a liquid delivery tube coupling the condenser to the heat exchanger for conveying cryogenic liquid condensed in the condenser to the heat exchanger, and a gas return tube coupling the heat exchanger to the condenser for returning cryogen vapor evaporated from the cryogenic liquid in the heat exchanger to the condenser.

### TECHNICAL FIELD

The present disclosure relates to a method and apparatus for cooling a superconducting device immersed in liquid nitrogen.

### BACKGROUND ART

The properties of common materials often change when the materials are cooled to a cryogenic temperature, and these changes complicate the design of cryogenic apparatus. These changes become substantial below a temperature of about 150 degrees Kelvin. Therefore, in this disclosure, “cryogenic” relates to a temperature below 150 degrees Kelvin. For example, “cryogenic liquid” is a liquid that has a boiling point below 150 degrees Kelvin. Examples of cryogenic liquid include liquid helium, hydrogen, neon, nitrogen, fluorine, argon, oxygen, and krypton.

High temperature superconductor (HTS) is a superconductor having a transition temperature above thirty degrees Kelvin (−243.2° C.). The transition temperature is the temperature below which the superconductor becomes superconducting in the absence of a magnetic field. In the presence of a magnetic field, the superconductor becomes superconducting at a temperature lower than the transition temperature. At a temperature lower than the transition temperature, there is a critical current density above which the superconductor exhibits significant resistance, by definition at an electric field of 1 μV/cm. Therefore is it often desirable to operate a HTS magnet at a temperature substantially lower than the transition temperature in order to achieve high current densities.

A number of HTS have a relatively high critical current density in a temperature range (63.15 to 77.35 degrees Kelvin) for which nitrogen is a liquid at atmospheric pressure. Some of these HTS are in commercial production, such as Bi2223, and YBa₂Cu₃O₇ and the rare-earth substituted variants of YBa₂Cu₃O₇ referred to as REBCO or more loosely as 2G HTS conductors. Therefore liquid nitrogen is a most convenient and relatively inexpensive refrigerant or heat transfer fluid for use with these HTS.

Usually a superconducting device is operated so that the magnet current is significantly less than the critical current. Otherwise, there is a likelihood that the superconducting magnet may revert to a non-superconducting state, causing a release of heat from current flowing in the magnet. Such an event of losing the superconducting state is called a quench. To prevent the release of heat during a quench from damaging the superconducting magnet, the superconducting magnet often is immersed in liquid cryogen so that the liquid cryogen may boil off to absorb the heat. Although a quench usually is not desired, a superconducting fault current limiter relies on a controlled quench in order to limit a fault current that substantially exceeds a normal level of current. See, for example, Yazawa et al., Design and Test Results of 6.6 kV High-Tc Superconducting Fault Current Limiter, IEEE Transactions on Applied Superconductivity, Vol. 11, No. 1, March 2001, pp. 2511-2514.

For continuous operation, an HTS device typically is immersed in liquid nitrogen contained in a thermally insulated cryostat, and the HTS device is thermally coupled to a cryocooler for cooling the superconducting device. HTS devices have been thermally coupled to cryocoolers in various way, for example by forced convection of helium gas or subcooled liquid nitrogen, and by natural convection of subcooled liquid nitrogen, as shown in FIGS. 1 and 2 of Ho-Ming Chang et al., Cryogenic cooling system of HTS transformers by natural convection of subcooled liquid nitrogen, Cryogenics 43 (2003) pages 489-596, Elsevier Ltd, London, UK.

### SUMMARY OF THE DISCLOSURE

In accordance with one aspect, the disclosure describes an apparatus for cooling a superconducting device. The apparatus includes a thermally insulated cryostat for containing liquid nitrogen in which the superconducting device is immersed, a cryocooler for cooling the superconducting device, and a cryogenic fluid circuit for thermally coupling the superconducting device a cold head of the cryocooler. The cryogenic fluid circuit includes a heat exchanger in the cryostat for immersion in the liquid nitrogen, a condenser thermally coupled to the cold head, a liquid delivery tube coupling the condenser to the heat exchanger for conveying cryogenic liquid condensed in the condenser to the heat exchanger, and a gas return tube coupling the heat exchanger to the condenser for returning cryogen vapor evaporated from the cryogenic liquid in the heat exchanger to the condenser, so that heat transfer between the superconducting device and the heat exchanger is operable by free convection of liquid nitrogen in the cryostat, and heat transfer between the heat exchanger and the cold head of the cryocooler is operable by circulation of a separate volume of cryogen in liquid and vapor phase in the cryogenic fluid circuit.

In accordance with another aspect, the disclosure describes a method of cooling a superconducting device. The method includes immersing the superconducting device in liquid nitrogen contained in a thermally insulated cryostat, and thermally coupling the superconducting device to a cold head of a cryocooler through a cryogenic fluid circuit. The cryogenic fluid circuit includes a heat exchanger immersed in the liquid nitrogen in the cryostat, a condenser thermally coupled to the cold head, a liquid delivery tube coupling the condenser to the heat exchanger for conveying cryogenic liquid condensed in the condenser to the heat exchanger, and a gas return tube coupling the heat exchanger to the condenser for returning cryogen vapor evaporated from the cryogenic liquid in the heat exchanger to the condenser. Heat transfer between the superconducting device and the heat exchanger occurs by free convection of the liquid nitrogen in the cryostat, and heat transfer between the heat exchanger and the cold head of the cryocooler occurs by circulation of a separate volume of cryogen in liquid and vapor phase in the cryogenic fluid circuit.

### BRIEF DESCRIPTION OF THE DRAWINGS

FIG. 1 is a schematic diagram of an apparatus including a superconducting device immersed in liquid cryogen.

FIG. 2 is a schematic diagram of heat flow from the superconducting device to the ambient environment around the apparatus of FIG. 1.

FIG. 3 is a schematic diagram of a partial assembly of a superconducting transformer and a cooling system for the superconducting transformer.

FIG. 4 is a schematic diagram of a more complete assembly of the superconducting transformer and cooling system of FIG. 3.

While the invention is susceptible to various modifications and alternative forms, specific embodiments thereof have been shown in the drawings and will be described in detail. It should be understood, however, that it is not intended to limit the invention to the particular forms shown, but on the contrary, the intention is to cover all modifications, equivalents, and alternatives falling within the scope of the invention as defined by the appended claims.

### DETAILED DESCRIPTION OF THE PREFERRED EMBODIMENTS

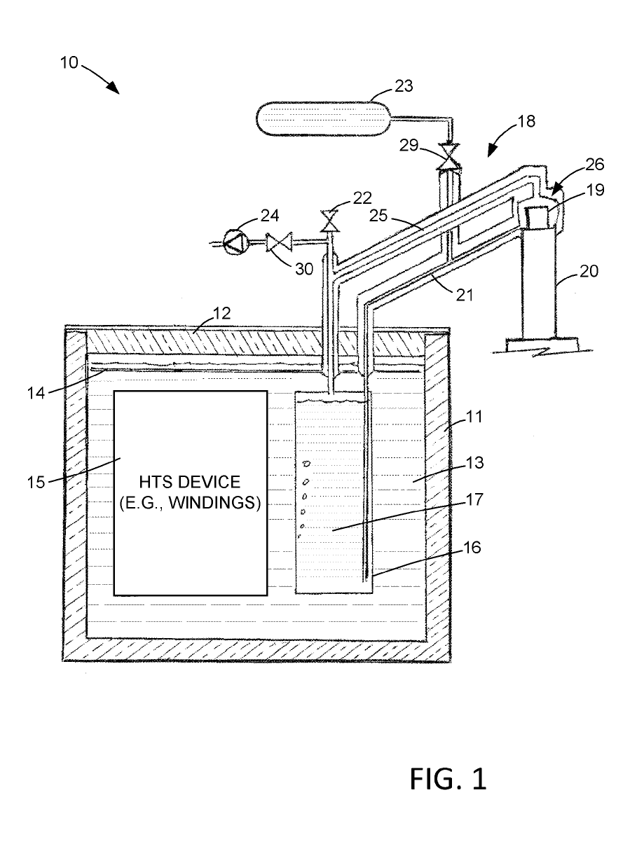

FIG. 1 shows an apparatus 10 including a high temperature superconductor (HTS) device 15 immersed in liquid nitrogen 13 contained in a thermally insulated vessel 11 functioning as a cryostat. For example, the HTS of the device 15 includes windings of Bi2223 or REBCO HTS, and the device 15 is a superconducting magnet, a superconducting fault current limiter, a winding of a superconducting transformer, or a superconducting energy storage inductor.

The thermally insulated cryostat 11 is sealed with a thermally insulated lid 12 in order to contain the liquid nitrogen 13 in the cryostat. For example, the cryostat 11 is capable of containing a pressure of three atmospheres above atmospheric pressure, and the cryogenic fluid circuit 18 is also capable of containing a pressure of three atmospheres above atmospheric pressure. For transformer applications the liquid nitrogen 13 in the neighborhood of the HTS windings 15 will normally be cooled to temperatures lower than its boiling point at atmospheric pressure, nominally 77 K. In other words, the liquid nitrogen 13 in the cryostat 11 is “subcooled.” For example, the liquid nitrogen 13 in the neighborhood of the HTS windings 15 is cooled to a temperature of 65 Kelvins or lower.

Normally it is advantageous to operate the cryostat 11 at a pressure slightly above atmospheric pressure, or possibly at an elevated pressure up to 2-3 atmospheres above atmospheric, in order to prevent water vapor from the external environment from leaking into the cryostat 11. This is achieved by maintaining the surface of the liquid nitrogen at the temperature at which its saturated vapor pressure (SVP) corresponds to the operating pressure, nominally 77 K for 1 atm. operating pressure, by arranging for the surface liquid to be stratified or separated with a physical barrier 14 to prevent vertical mixing from the colder liquid surrounding the superconducting device 15 being cooled.

For cooling the HTS device 15, the apparatus 10 includes a cryocooler 20 and a cryogenic fluid circuit 18 thermally coupling the HTS device 15 to a cold head 19 of the cryocooler. The cryogenic fluid circuit 18 includes a heat exchanger 16 functioning as a vaporizer in the cryostat 11 for immersion in the liquid nitrogen 13, a condenser 26 thermally coupled to the cold head 19, a liquid delivery tube 21 coupling the condenser 26 to the heat exchanger 16 for conveying cryogenic liquid condensed in the condenser to the heat exchanger, and a gas return tube 25 coupling the heat exchanger to the condenser for returning cryogen vapor evaporated from the cryogenic fluid in the heat exchanger to the condenser, so that heat transfer between the superconducting device 15 and heat exchanger 16 is operable by free convection of the liquid nitrogen in the cryostat 11, and heat transfer between the heat exchanger 16 and the cold head 19 of the cryocooler 20 is operable by circulation of a separate volume of cryogen in liquid and vapor phase in the cryogenic fluid circuit 18.

The cryogenic fluid circuit 18 is configured as a heat pipe or thermosiphon in which a separate volume of cryogen in the cryogenic fluid circuit 18 circulates without the aid of a pump. More specifically, FIG. 1 shows the cryogenic fluid circuit 18 as a thermosiphon, in which the condenser 26 is elevated with respect to the heat exchanger 16. The heat exchanger 16 functioning as a vaporizer is positioned so that it is immersed in the subcooled liquid nitrogen 13 in the lower part of the cryostat 11. The heat exchanger 16 contains a cryogenic liquid 17 at its boiling point with the vaporized gas conducted through a thermally insulated gas delivery tube 25 to the condenser 26 at the cold head 19 of the cryocooler 20. The condensed liquid flows back under the force of gravity to the heat exchanger 16 through a thermally insulated liquid return tube 21. For example, the gas delivery tube 25 and the liquid return tube 21 are each comprised of dual coaxial tubes having a vacuum insulated gap between them. A pressure relief valve 22 prevents over-pressuring of the cryogenic fluid circuit 18 by automatically relieving pressure in the cryogenic fluid circuit when the pressure in the cryogenic fluid circuit exceeds a pressure limit. A liquid cryogen supply tank 23 and a vacuum pump 24 are provided with respective valves 29 and 30 for filling operations and for short-term evaporative cooling when the cryocooler 20 is inoperative.

In a specific example, the liquid cryogen 17 in the heat exchanger 16 operates at 65 K or lower with internal pressure corresponding to the saturated vapor pressure (SVP) of the cryogen 17 at the temperature of the heat exchanger 16. (SVP is defined as the vapor pressure at which the gaseous phase of a substance and the liquid or solid phase of the substance exist in equilibrium at a given temperature.) Normally the pressure in the cryostat 11 may be greater than the SVP of the liquid nitrogen 13 surrounding the HTS device 15 to be cooled and surrounding the heat exchanger 16, so that this liquid nitrogen is subcooled. The pressure in the cryogenic fluid circuit 18 may be lower than the pressure in the cryostat in order to promote nucleate boiling of the cryogenic fluid in the heat exchanger 16.

The heat exchanger 16 can be in the form of a large surface area vessel having a thin metal wall designed to withstand vacuum and moderate positive pressures. The thin metal wall, for example, is made of high purity copper or aluminum for good heat conductivity to obtain a temperature drop across the wall of less than 0.1 K. The heat exchanger 16 may have the form of a manifold of pipes or similar elements, or it may be planar in form or planar with corrugations to increase the surface to volume ratio. The heat exchanger 16 may be enclosed within the cryostat 11 containing the HTS device 15 to be cooled. For a large HTS device such a transformer or current limiter, the heat exchanger 16 could be several meters in height or width and have a thickness of a few centimeters, and the heat exchanger could encircle the HTS windings of the HTS device.

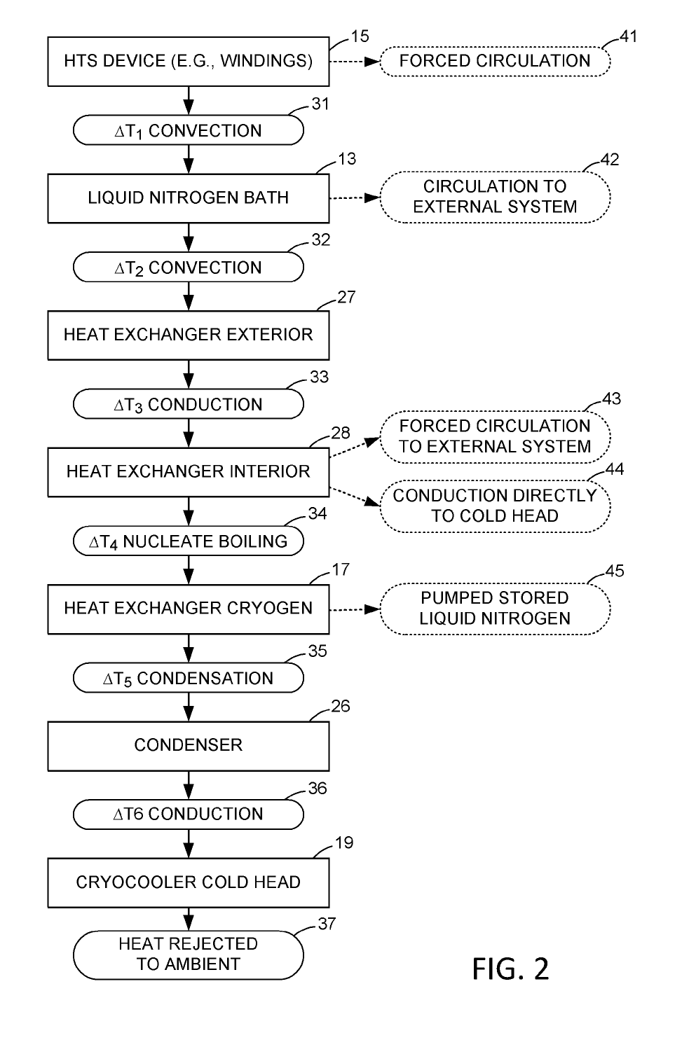

FIG. 2 shows heat transfer through the system 10 of FIG. 1 from the HTS device 15 to the cryocooler cold head 19. In a first process of convection 31, heat flows from the HTS device 15 to the liquid nitrogen bath 13 in the cryostat, and this convection is driven by a temperature drop ΔT₁ from the HTS device 15 to the liquid nitrogen bath 13. In a second process of convection 32, heat flows from the liquid nitrogen bath 13 to an exterior surface 27 of the heat exchanger (16 in FIG. 1), and this convection is driven by a temperature drop ΔT₂ from the liquid nitrogen bath 13 to the exterior surface 27 of the heat exchanger. In a third process of conduction 33 though the wall of the heat exchanger (16 in FIG. 1), the heat flows from the exterior surface 27 to the interior surface 28 of the heat exchanger. This conduction 33 is driven by a temperature drop ΔT₃ from the exterior of the heat exchanger to the interior of the heat exchanger. For example, the surface area of the wall of the heat exchanger is sufficient to provide the required heat transfer per unit area between its external surface and the liquid nitrogen in the cryostat with minimal temperature drop, preferably less than 1 K, using an effective surface area of more than 1 m² per kW of convective heat transfer.

In a fourth process of nucleate boiling 34, the heat flows from the interior surface 38 of the heat exchanger to heat exchanger cryogen 17 in the vapor phase. This nucleate boiling 34 is driven by a temperature drop ΔT₄ from the interior surface 38 of the heat exchanger to the heat exchanger cryogen 17 in the vapor phase. The heat exchanger can be filled with liquid cryogen so that nucleate boiling of the liquid cryogen occurs over most of the wall area of the heat exchanger. In a fifth process of condensation 35, the heat flows from the heat exchanger cryogen in the vapor phase to the condenser 26. This condensation is driven by a temperature drop ΔT₅ from the heat exchanger cryogen in the vapor phase to the condenser 26. In a sixth process of conduction, the heat flows from the condenser 26 to the cryocooler cold head 19. This conduction is driven by a temperature drop ΔT₆ from the condenser 26 to the cryocooler cold head 19. Finally, in a seventh process 37, the cryocooler (20 in FIG. 1) removes the heat from the cold head and rejects the heat to the ambient environment.

The heat flow by the sequence of heat transfer processes 31, 32, 33, 34, 35, 36, 37 provides an efficient, economical, and reliable method of cooling the HTS device immersed in the liquid nitrogen in the cryostat. The heat exchanger in which cryogen is vaporized to extract heat from the subcooled pool of liquid nitrogen exploits a high heat transfer efficiency of the nucleate boiling 34 on the interior surface of the heat exchanger. The condensation 35 of the cryogen vapor in the condenser also has high heat transfer efficiency. Overall, the sequence of heat transfer processes in FIG. 2 may ensure that during cooling of a HTS device such as a HTS transformer during normal operation at a high load factor, there is a temperature drop of no more than two Kelvins from the superconductor windings of the transformer to the cold head of the cryocooler.

The composition of the cryogenic fluid in the heat exchanger and in the condenser can be selected to obtain an acceptable range of operational temperature of the HTS device (e.g., from about 77 K down to about 64 K) without excessive pressure in the cryostat or in the heat exchanger and condenser (e.g., less than 3 atmospheres above atmospheric). For example, the temperature in the condenser in the neighborhood of the cryocooler cold head is in the range of 63 to 54 K, and the temperature of the heat exchanger is in the range of 64 to 66 K. An effective limit to the lowest temperature of cooling of the HTS device is imposed by freezing of the cryogen in the condenser in the neighborhood of the cryocooler cold head. This occurs at 63.15 K for pure nitrogen. This lower limit could be extended by using mixtures of cryogenic fluid, for example, nitrogen mixed with a cryogen having a lower freezing point than nitrogen, such as nitrogen mixed with oxygen or neon. Then the cold head of the cryocooler may have a temperature of 63 Kelvins or lower during operation of the apparatus 10 of FIG. 1, in order to cool the HTS device 15 to a minimum temperature very near the freezing point of the liquid nitrogen in the cryostat 11. Reduction of the nitrogen freezing point by no more than a few Kelvin is sufficient so that the limiting temperature is the critical point for nitrogen on the outside surface of the heat exchanger.

For example, a major portion of the cryogen is nitrogen, and a minor portion of the cryogen is oxygen or neon, so that the external temperature of the heat exchanger can be 65 Kelvins or lower during cooling of the superconducting device. For example, the cryogen is a mixture of at least seventy-eight mole percent of nitrogen, and oxygen in the range of two mole percent to twenty-one mole percent. For example, the cryogen is obtained from air that has been liquefied in a cooling process that removes water vapor, carbon dioxide, and other components that are not cryogenic, resulting in a mixture of about 78% nitrogen, 21% oxygen, and 1% argon.

For example, the nitrogen freezing point is reduced by no more than a few Kelvin by mixing some oxygen with nitrogen. Oxygen has a freezing point of 54 K. Taking the freezing point for liquid air to be 57 K, an admixture of less than 5 mole % of oxygen will lower the freezing point by more than one Kelvin, allowing the operating point of the HTS device to be lowered by a similar margin.

The total amount of oxygen in the heat exchanger 16, condenser 26, liquid delivery tube 21, and gas return tube 25 can be a small fraction of the total amount of liquid nitrogen in the cryostat. For example, a flat plate heat exchanger for a 50 MVA transformer may have an area 3.5×1.5 m and thickness 0.02 m and contain only 0.1 m³ of cryogen, while the volume of liquid nitrogen in the cryostat may be 5 to 10 m³. Therefore, in the event of a malfunction or disaster in which there would be a rupture of the cryogenic fluid circuit and the cryostat, the oxygen would be diluted by mixing with the nitrogen so that the concentration of the oxygen would be insufficient to sustain combustion.

In dashed line representation, FIG. 2 shows additional heat flow paths that could exist in an apparatus similar to the apparatus 10 of FIG. 1. Some heat could flow from the HTS device 15 by forced circulation 41 within the cryostat. However, forced circulation of the liquid nitrogen within the cryostat would use a cryogenic pump adding expense and decreasing reliability. Therefore forced circulation is not desired if free convection would provide adequate heat transfer.

Some heat could flow from the liquid nitrogen bath 13 via circulation 42 of the liquid nitrogen to an external system, such as to a heat exchanger mounted on a cold head of a cryocooler external to the cryostat. However, the circulation of the liquid nitrogen to an external system and back to the cryostat may not provide adequate heat transfer or an acceptable temperature drop unless the circulation is forced.

Some heat could flow from the heat exchanger interior 28 via forced circulation 43 to an external system. However, the forced circulation would again require a cryogenic pump adding expense and decreasing reliability. The cryogenic pump could be a cryogenic fan assisting a flow of cryogen vapor from the heat exchanger to the condenser. Some heat could also flow from the heat exchanger interior 28 via by conduction 44 directly to the cold head of the cryocooler. In this case the heat flow might not be adequate unless the cold head is in the cryostat or coupled to the heat exchanger interior 28 by a sufficient mass of heat conductive material such as high purity copper or aluminum.

Some heat could be removed from the heat exchanger by using pumped stored liquid cryogen 45. This could be effective for temporary cooling of the HTS device in the event that the cryocooler is inoperative due to failure, repair, or replacement of the cryocooler. For example, in the apparatus 10 of FIG. 1, liquid cryogen is admitted from the tank 24 through a valve 29, and the liquid cryogen flows down through the liquid delivery tube 21 in to the interior of the heat exchanger 16. The vacuum pump 24 is turned on and a valve 30 is opened so that the liquid cryogen in the heat exchanger 16 is vaporized and the cryogen vapor is evacuated from the cryogenic fluid circuit through the valve 30 and the vacuum pump 34. The vaporization of the liquid cryogen in the heat exchanger cools the heat exchanger 16, which in turn cools the HTS device 15.

The apparatus in FIG. 1 and the method in FIG. 2 can be applied to large as well as small HTS devices. However, the reduced capital cost and increased efficiency of the apparatus in FIG. 1 and the method in FIG. 2 are especially desirable for power grid applications in order to enable large HTS transformers to be cost competitive with conventional oil-immersed copper transformers.

Modelling results for a 40 MVA 110/11 kV HTS transformer winding predict that a transformer of this rating operating at 65 K could have as little as one quarter of the load losses of a conventional transformer when coupled with a high efficiency cryocooler (1/COP˜15²). Outside niche markets like mobile transformers, the commercial viability of HTS transformers depends on exploiting the lower lifetime cost of losses of an HTS transformer to offset its higher purchase price to achieve a lower total cost of ownership (TCO) than a conventional transformer. The lifetime cost of losses for conventional transformers which operate constantly at rated power, i.e. with a high load factor, make a very large contribution to the TCO—they may be twice the purchase price, depending on assumptions about investment lifetime and discount rates used to calculate net present value. Generator step-up transformers (GSU) for base-load generation have load factors approaching 100% and so will be the first major market for HTS transformer technology.

For selecting cryocoolers for applications in which cost savings through efficiency is paramount, the relevant measure is the total cost of ownership per watt of cooling power which can be expressed:

$${TCO}_{cooler} = PPW + {A}_{f} ( PWM + \frac{LF \cdot A}{COP} )$$

where PPW is the purchase price per watt of cooling power, A_{f} is the availability factor, ideally 100%, PWM is the present worth of the lifetime maintenance costs, LF is the load factor, and A/COP is the lifetime cost of energy to run the cryocooler per watt of cooling power assuming a 100% load factor. A is the capitalised loss evaluation factor, the net present value per unit power of losses over the lifetime of the equipment. The values depend on the cost of power, and assumed financial discount rate and lifetime of the equipment. A reasonable value is up to 10 USD/W, although values vary widely. A comparison assuming 100% availability and load factor shows that single stage Stirling cryocoolers such as the SPC-4 significantly outperform other cryocoolers on this measure. This cryocooler delivers its cooling power as a cryogenerator by condensing incoming nitrogen gas to liquid. The required cooling load for a 40 MVA transformer is in the cooling power range of the SPC-4, 2.8 kW at 65 K. Gifford-McMahon (GM) cryocoolers, the competing mature cryocooler technology, are disadvantaged because of their relatively low efficiency and lower cooling capacity per unit, only 500 W at 65 K for the Cryomech AL600.

A recent cost study for a 40 MVA HTS transformer shows that wire cost is almost 40%, and the cooling system almost 30% of the total capital cost of USD 1.7 M, which is around double the purchase price of a conventional transformer including fire protection. These cost estimates assume the adoption of low cost cryostat and heat transfer technologies. Minimising wire and cooling system costs is essential for commercial viability.

The critical current of HTS coated conductor increases approximately linearly with decreasing temperature from zero at the critical temperature, typically around 90 K. The difference in critical current between operating temperatures of 65 and 66 K is typically around 4%. Given conductor costs for a 40 MVA transformer of around 0.6 M USD, each Kelvin reduction in operating temperature is worth around 25,000 USD. Therefore the temperature drops should be minimized in the sequence of heat transfers from the HTS transformer windings to the cryocooler cold head. For example, using the apparatus 10 in FIG. 1 and the method of FIG. 2, the temperature drops are ΔT1 to ΔT6 in the heat transfers 31 to 36 in FIG. 2.

HTS transformer winding cooling by natural convection is preferred, because forced circulation within the transformer cryostat requires one or more cryogenic pumps adding expense and decreasing reliability. Experimental data for liquid to solid interface heat transfer in the conduction regime can described by

$$( \frac{{Q}_{c}}{A} ) = {h}_{c} Δ T$$

where the conductive heat transfer coefficient h_{c} has a value of about 1000 Wm⁻²K⁻¹.

A three phase 40 MVA transformer will have six windings each roughly 0.5 m in diameter by 1.5 m height for an external surface area of almost 15 m² so that the expected temperature drop ΔT₁ is under 0.2 K, assuming a dissipation of 750 W/phase, and heat transfer only from the exterior surface of the windings. For example, the windings are wrapped with electrical insulation, and the dissipation will tend to be concentrated in the end turns of the winding rather than evenly distributed.

One or more large area heat exchanger can be fitted within a HTS transformer cryostat. For example, a single cryostat contains all of the three phase windings of the HTS transformer. The single cold volume of the single cryostat minimizes the losses in the current leads that pass through the lid of the cryostat to connect the HTS windings to the external ambient environment.

The volume of cryogen for a 50 MVA class transformer will be about 10 m³, with the internal dimensions of the cryostat tank around 3.5×1.7×1.7 m, allowing space for an on-load tap changer. A flat plate heat exchanger can have an area 3.5×1.5 m, or around 10 m² (both sides) or perhaps double this allowing for a corrugated wall profile. Assuming the same heat transfer coefficient h_{c} of 10³ Wm⁻²K⁻¹ as above and 2.8 kW of heat transfer, the temperature difference ΔT₂ can be kept under 0.15 K.

Although the heat exchanger could be directly coupled to the cold head of a cryocooler, this is not ideal because it is not possible to design a heat exchanger which combines sufficiently high surface area to give a low temperature drop for the heat transfer across the liquid-solid interface with a low temperature drop in the heat exchanger material, even using high purity aluminium or copper. The thermal resistance of bolted joints and the maintenance requirements for cold heads immersed in the cryostat are additional problems.

For the heat flux as above, with thermal conductivity 10 Wm⁻¹K⁻¹ and with 2 mm wall thickness, the temperature drop ΔT₃ through the heat exchanger wall is less than 0.03 K. (A low value of thermal conductivity is assumed, in the range for stainless steel at 70 K, since the heat exchanger material may need to have low electrical conductivity to minimize eddy current losses in the stray magnetic field of the transformer.) Despite the low conductivity of the wall material the temperature drop is almost negligible. The cryogenic fluid circuit (18 in FIG. 1) is configured as a heat pipe to provide a high thermal conductance link to the cryocooler, which can be external to the cryostat. In general, a heat pipe is a heat-transfer device that combines the principles of both thermal conductivity and phase transition to efficiently manage the transfer of heat between two solid interfaces. At the hot interface of a heat pipe a liquid in contact with a thermally conductive solid surface turns into a vapour by absorbing heat from that surface. The vapour then travels along the heat pipe to the cold interface and condenses back into a liquid—releasing the latent heat. The liquid then returns to the hot interface through either capillary action, centrifugal force, or gravity, and the cycle repeats. Due to the very high heat transfer coefficients for boiling and condensation, heat pipes are highly effective thermal conductors. A heat pipe known as a thermosiphon uses gravity to return liquid from the condenser to the evaporator.

In the apparatus 10 in FIG. 1, the cryogenic fluid circuit 18 is configured as a thermosiphon, and this permits the liquid delivery tube 21 and the gas return tube 25 to pass from the heat exchanger 16 in the cryostat 11 through the lid 12 of the cryostat up to an elevated cold head 19 of the cryocooler 20. Because the liquid delivery tube and the gas return tube are insulated, the cryocooler cold head 19 can be spaced horizontally from transformer cryostat 11, and there can be ample clearance above the lid 12 for current leads protruding from the lid and electrical connections of the current leads to power lines above the lid.

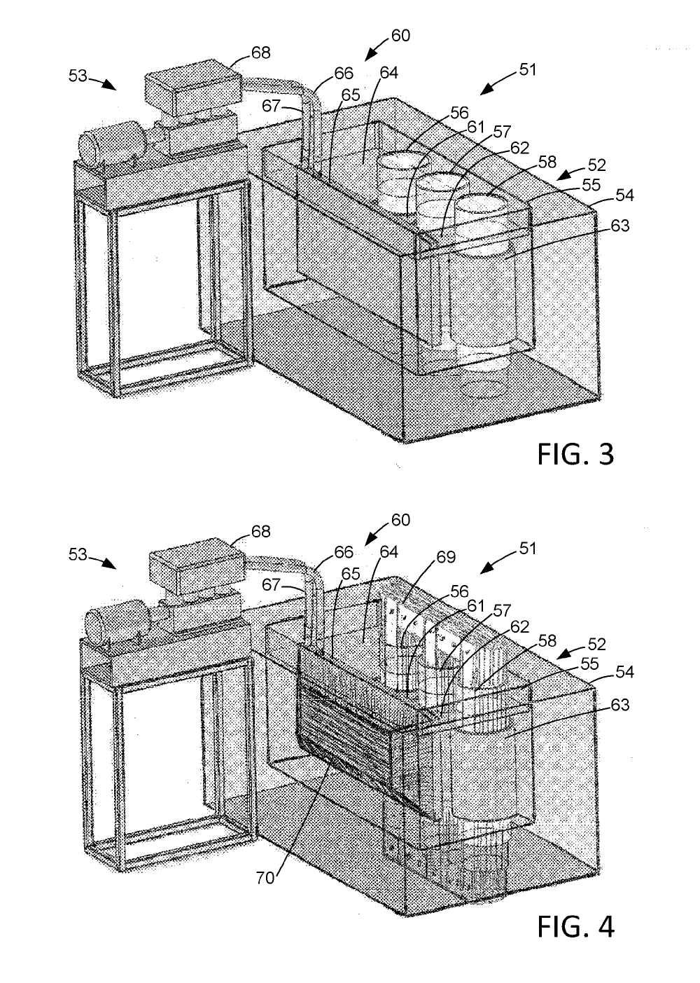

FIG. 3, for example, shows a schematic diagram of a partial assembly of a superconducting transformer system 51 including a thermally insulated cryostat 52 for containing liquid nitrogen in which components of a superconducting transformer are immersed, and a cryocooler 53 for cooling the components of the superconducting transformer. The cryostat 52 includes an outer wall 54 and an inner wall 55. The walls 54, 55 appear transparent in FIG. 3 so that the components inside the cryostat 52 are visible, although in practice the walls 54, 55 would be opaque. In addition, the space between the walls 54, 55 is filled with thermal insulation such as plastic foam.

Three cylindrical thermally insulating tubes 56, 57, and 58 provide respective parallel spaced vertical holes through the cryostat 52. A respective high temperature superconductor coil assembly 61, 62, 63 encircles each of the thermally insulating tubes 56, 57, 58. For example, each superconducting coil assembly 61, 62, 63 includes a primary coil and a secondary coil for a respective one of three phases of the transformer. The inner wall 55 defines a rectangular container filled with liquid nitrogen 64 immersing the superconductor coil assemblies 61, 62, 63.

In order to cool the superconductor coil assemblies 61, 62, 63, a cryogenic fluid circuit 60 thermally couples the superconducting coil assemblies 61, 62, 63 to a cold head of the cryocooler 53. The cryogenic fluid circuit 60 includes a heat exchanger 65 immersed in the liquid nitrogen 64 in the cryostat, a condenser 68 thermally coupled to the cold head of the cryocooler 53, a thermally insulated liquid delivery tube 66 coupling the condenser to the heat exchanger for conveying cryogenic liquid condensed in the condenser to the heat exchanger, and a thermally insulated gas return tube 67 coupling the heat exchanger to the condenser for returning cryogen vapor evaporated from the cryogenic liquid in the heat exchanger to the condenser. The heat exchanger 65 is a metal box in the form of a vertical rectangular plate, and the superconducting coil assemblies 61, 62, 63 are located on one side of the rectangular plate, and the other side of the rectangular plate faces the inner wall 55 of the cryostat 52.

FIG. 4 shows silicon steel laminations of a ferromagnetic core 69 assembled in the holes of the thermally insulating tubes 56, 57, 58 and protruding above and below the cryostat 52. For example, the top of the ferromagnetic core 69 protrudes from a lid that seals the liquid nitrogen 64 in the cryostat. FIG. 4 also show a mounting plate 70 of thermally insulating material disposed between the heat exchanger 65 and the inner wall 55 of the cryostat.

1. Apparatus for cooling a superconducting device, said apparatus comprising:
a thermally insulated cryostat for containing liquid nitrogen in which the superconducting device is immersed;
a cryocooler for cooling the superconducting device; and
a cryogenic fluid circuit for thermally coupling the superconducting device to a cold head of the cryocooler;
wherein the cryogenic fluid circuit includes a heat exchanger in the cryostat for immersion in the liquid nitrogen, a condenser thermally coupled to the cold head, a liquid delivery tube coupling the condenser to the heat exchanger for conveying cryogenic liquid condensed in the condenser to the heat exchanger, and a gas return tube coupling the heat exchanger to the condenser for returning cryogen vapor evaporated from the cryogenic liquid in the heat exchanger to the condenser, so that heat transfer between the superconducting device and the heat exchanger is operable by free convection of liquid nitrogen in the cryostat, and heat transfer between the heat exchanger and the cold head of the cryocooler is operable by circulation of a separate volume of cryogen in liquid and vapor phase in the cryogenic fluid circuit.

2. The apparatus as claimed in claim 1, wherein the cryocooler and the cold head are external to the cryostat, and the liquid delivery tube is insulated, and the gas return tube is insulated.

3. The apparatus of claim 1, wherein the cold head is elevated above the heat exchanger for cryogenic liquid condensed in the condenser to flow to the heat exchanger under the force of gravity.

4. The apparatus of claim 1, wherein the cold head is elevated above a lid of the cryostat, a liquid delivery tube passes thorough the lid of the cryostat, and the gas return tube passes through the lid of the cryostat.

5. The apparatus of claim 1, wherein cryostat is capable of containing a pressure of three atmospheres above atmospheric pressure, and the cryogenic fluid circuit is capable of containing a pressure of three atmospheres above atmospheric pressure.

6. The apparatus of claim 1, further including a pressure relief valve coupled to the cryogenic fluid circuit for automatically relieving pressure in the cryogenic fluid circuit when the pressure in the cryogenic fluid circuit exceeds a pressure limit.

7. The apparatus of claim 1, further including a tank for holding the liquid cryogen, and a valve coupled between the tank and the heat exchanger for selectively permitting liquid cryogen from the tank to flow into the heat exchanger.

8. The apparatus of claim 1, further including a vacuum pump coupled to the heat exchanger for removing cryogen vapor from the heat exchanger.

9. The apparatus of claim 1, wherein the superconducting device is a transformer including windings of high temperature superconductor.

10. A method of cooling a superconducting device, said method comprising:
immersing the superconducting device in liquid nitrogen contained in a thermally insulated cryostat; and
thermally coupling the superconducting device to a cold head of a cryocooler through a cryogenic fluid circuit, wherein the cryogenic fluid circuit includes a heat exchanger immersed in the liquid nitrogen in the cryostat, a condenser thermally coupled to the cold head, a liquid delivery tube coupling the condenser to the heat exchanger for conveying cryogenic liquid condensed in the condenser to the heat exchanger, and a gas return tube coupling the heat exchanger to the condenser for returning cryogen vapor evaporated from the cryogenic liquid in the heat exchanger to the condenser, and heat transfer between the superconducting device and the heat exchanger occurs by free convection of the liquid nitrogen in the cryostat, and heat transfer between the heat exchanger and the cold head of the cryocooler occurs by circulation of a separate volume of cryogen in liquid and vapor phase in the cryogenic fluid circuit.

11. The method as claimed in claim 10, wherein the cryocooler and the cold head are external to the cryostat, the liquid delivery tube is insulated, the gas return tube is insulated, and the cold head is elevated above the heat exchanger so that cryogenic liquid condensed in the condenser flows to the heat exchanger under the force of gravity.

12. The method of claim 10, wherein the superconducting device is cooled by the liquid nitrogen to a temperature of 65 kelvin or lower.

13. The method of claim 10, wherein the liquid nitrogen neighboring the superconducting device is cooled to a temperature lower than the boiling point of the liquid nitrogen at atmospheric pressure.

14. The method of claim 10, wherein pressure greater than atmospheric pressure is contained in the cryostat.

15. The method of claim 10, wherein pressure in the cryogenic fluid circuit is less than pressure in the cryostat.

16. The method of claim 10, wherein the cold head of the cryostat has a temperature of 63 Kelvins or lower.

17. The method of claim 10, wherein a major portion of the cryogen in the cryogenic fluid circuit is nitrogen, and a minor portion of the cryogen in the cryogenic fluid circuit is oxygen or neon, and the external temperature of the heat exchanger is 65 Kelvins or lower during cooling of the superconducting device.

18. The method of claim 10, wherein the cryogen in the cryogenic fluid circuit is a mixture of at least seventy-eight mole percent of nitrogen, and
oxygen in the range of two mole percent to twenty-one mole percent.

19. The method of claim 17, wherein the cryogen in the cryogenic fluid circuit contains less than five mole percent of oxygen.

20. The method of claim 10, wherein the superconducting device is a winding of high temperature superconductor of a transformer, and during cooling of the superconducting device during operation of the transformer, there is a temperature drop of no more than two Kelvins from superconductor windings of the transformer to the cold head of the cryocooler.

21. The method of claim 10, further including a pressure relief valve coupled to the cryogenic fluid circuit automatically relieving pressure in the cryogenic fluid circuit when the pressure in the cryogenic fluid circuit exceeds a pressure limit.

22. The method of claim 10, further including admitting cryogenic liquid into the heat exchanger and evacuating cryogenic vapor from the heat exchanger to cool the superconducting device when the cryocooler is inoperative.
